(19) United States
(12) Patent Application Publication
(10) Pub. No.: US 2019/0278461 A1
(43) Pub. Date: Sep. 12, 2019

(54) RECOMMENDATION ACKNOWLEDGEMENT AND TRACKING

(71) Applicant: MUDPIE, SA DE CV, Roma (MX)

(72) Inventor: Mildred Villafañe, Lomas de Chapultepec (MX)

(21) Appl. No.: 16/294,263

(22) Filed: Mar. 6, 2019

Related U.S. Application Data
(63) Continuation-in-part of application No. 16/273,063, filed on Feb. 11, 2019.
(60) Provisional application No. 62/639,445, filed on Mar. 6, 2018.

(51) Int. Cl. G06F 3/0481; G06F 16/9535; G06F 3/0484

(52) U.S. Cl. CPC G06F 3/04817; G06F 3/04842; G06F 16/9535

(57) ABSTRACT

Techniques are described that provide a platform and methods through which a user's motivation for an action taken by the user can be attributed to influence from information provided by an initial user. The techniques provide an easy way for the user to explicitly provide direct evidence of the user's motivation. Also, the techniques demonstrate a highly reliable way as to how motivation may be inferred from certain context in which the user operates and the user can be prompted to confirm the motivation inference. Indications of the user's motivations may also be linked to a creation (post, text, message, etc.) by the initial user to assist in search operations to provide more thorough and accurate search results.

### CROSS-REFERENCE TO RELATED APPLICATIONS

This application claims priority to U.S. Provisional Patent Application No. 62/639,445 filed on Mar. 6, 2018, which is entirely incorporated by reference herein. This application is a continuation-in-part of U.S. patent application Ser. No. 16/273,063, entitled “User Created Content Referral and Search,” filed on Feb. 11, 2019, which is entirely incorporated by reference herein. This application is also a continuation-in-part of U.S. patent application Ser. No. ______, entitled Search Engine Scoring and Ranking, filed on Mar. 6, 2019, which is entirely incorporated by reference.

### BACKGROUND

Over the last few years, use of Internet search engines has become one of the leading ways that people locate things of interest to them. The significant increase has led interested parties, such as Internet providers, application, online merchants, social media platforms, etc., to seek how end users are motivated to take some of the actions that they do. Many users provide recommendations reflecting their opinion about all manner of people, places, things, etc., but there are very few ways to know if other users are actually relying on such recommendations to take actions, such as to patronize a restaurant or play, to purchase a product, to read a book, etc. All this has given rise to the notion of online “influencers,” who are online personalities that provide recommendations to the public, which may result in other people taking an action because a particular person made the recommendation. Much interest has been generated around the idea of identifying such influencers. However, identifying influencers is typically a matter of guesswork, such as determining that a person is an influencer because that person has an inordinate amount of followers, has received a number of “likes” or comments, etc. But there is no direct evidence that such a person's recommendations actually inspire actual actions by other users.

### SUMMARY

The techniques described herein provide a platform and method through which a user's motivation for an action taken by the user can be attributed to influence from a recommendation provided by an initial user. The techniques provide an easy way for the user to explicitly provide direct evidence of the user's motivation. Also, the techniques demonstrate a highly reliable way as to how motivation may be inferred from certain context in which the user operates and the user can be prompted to confirm the motivation inference. Indications of the user's motivations may also be linked to a creation (post, text, message, etc.) of the initial user to assist in search operations to provide more thorough and accurate search results.

### BRIEF DESCRIPTION OF THE DRAWINGS

The Detailed Description, below, makes reference to the accompanying figures. In the figures, the left-most digit(s) of a reference use of the same reference numbers in different figures indicates similar or identical items.

FIG. 1 illustrates an example of a content referral.

FIG. 2 is a block diagram representing an example electronic device on which one or more portions of the present techniques may be implemented.

FIG. 3 is a block diagram depicting an example server operational environment in accordance with the techniques described herein.

FIG. 4 depicts a representation of an example content referral database that may be utilized with the techniques described herein.

FIG. 5 depicts a representation of an example lists database that may be utilized with the techniques described herein.

FIG. 6 is a flow diagram that depicts an example methodological implementation for one or more processes presented herein, i.e. thanks.

FIG. 7 is a flow diagram that depicts an example methodological implementation for a thanks process.

FIG. 8 is a flow diagram that depicts an example methodological implementation for an automatically initiated thanks process.

### DETAILED DESCRIPTION

The technology described herein and in the incorporated patent applications relate to user created content referrals that create searchable content, and methods for providing direct attribution to influencers. Thus, highly reliable data related to influencers and determinations as to who might be an influencer, are provided. Information included on such user created content referrals provide a basis for an efficient search platform that users can use to quickly and easily find reliable search results, i.e., search results that are directly related to what users are searching for, such as products, places, businesses, people, etc. These techniques save users' time as well as computer and network resources in performing searches, since fewer searches are required to find relevant information and since the searched data set is smaller than a data set consisting of virtually everything on the Internet. Information from the content referrals and data related to the content referrals can be used to create databases of information. Because the contents of the searchable database are informed by identifiable users, a search of the database provides results that are more relevant to a user performing the search, and more reliable due to the searched information coming from a known source and/or trusted population of users. In addition, a user may limit a searched data set to one consisting of input from a single person (such as friend or a favorite celebrity) or a group of persons (typically a group of persons having at least one common characteristic, such as people in a certain geographic area, people of a certain age group, etc.).

Furthermore, users have at least partial control over ranking of subjects of user created content referrals for ranked lists (referred to herein as personal or global “lists” or “top ten lists,” although such lists are not limited to ten entries and may contain more or fewer than ten entries.)

Also disclosed herein are techniques whereby a user can take a direct action on an item found in a search result. For example, if a user searches for a particular product or type of product, the search will likely return one or more products. Actions can be associated with the products, such as an action to navigate to a site to purchase a particular product. Or, for example, if a user searches for restaurants in a particular neighborhood or specializing in a particular type of food, an action may be available whereby the user can make a reservation at a restaurant returned in a search result, order delivery from the restaurant, etc. Other actions may also be included.

Generally, users begin with a basic content entry user interface (referred to herein as a “content referral”) to enter media content, a title for the content referral, one or more categories with which the content referral is associated, and one or more ratings associated with a thing, person, etc. By associating multiple categories with a content referral, a user can increase the chances that the content referral will be identified in a search. It is noted that one or more of the items listed above (media content, title, categories, rating) may be omitted from a content referral creation process. Different implementations may require more or fewer of these and similar items.

When a content referral has been composed, the content referral can be posted by a user to a user feed, which is viewable by user connections, an identified group of people, the general public, etc. Other users may comment on a content referral in the author's feed and can use content of the content referral to create their own referral with at least some elements of the content referral. When a content referral is created, a record corresponding to the content referral is created in one or more databases to preserve the entry. As contemplated herein, a content referral record is created in a searchable content referral database. Other types of records may be created in other types of databases depending on the implementation. In the examples described herein, a database of lists is maintained, and certain elements of a content referral—such as a description name and category—are stored therein.

Search results from searches performed within the systems described herein are more reliable than current search applications. For one, search aggregators can be prevented from manipulating the system, thus allowing directly relevant search results to be ranked at the top of a results list. Additionally, a user can search a subset of the general population that is deemed by the user to have a more relevant understanding of what the user is searching for, thus allowing the user to reach a reliable result more quickly (i.e. with fewer search operations). For example, a user may wish to limit a search for a local restaurant to people who actually live in a neighborhood, who might frequent local restaurants more than people who live outside the neighborhood. Or a user may wish to look at a top ten list for a particular celebrity the user follows, so as to get a recommendation from the celebrity.

Another feature described herein is a technique that allows a seller of a product to determine a source of a buyer's motivation to purchase the product or service, such as a person that referred the buyer to the product or service (or a seller of the product or service). A user can use a “thanks” feature, or process, to express appreciation to a person on whose recommendation they relied on to purchase or explore interest in a product or service. When the thanks function is activated, a content referral associated with the thanks may be stored in a user's (the “thanking” user's) personal wish list, where the user can easily access and perform subsequent actions on the product or service, such as purchasing the product or service. The thanks process may also be used to give credit to a person who created original content used in a content referral.

By using the features of the systems and methods described herein, measurements can be made of the effects that peers' recommendations have on others. Sources of recommendations can be visualized with more accuracy than current social media analytics that only measure “engagement” actions between users, such as by way of a “like” feature or a “re-tweet.” Using the described technology, a thread between a first user's content referral (i.e. recommendation) and a second user's “thanks,” can be traced to identify a direct effect of the first user's referral on the second user's purchase. Further, influence of other users on the first user's recommendation can be identified. Once such relationships between user recommendations and purchases is identified, not only can influences from any given entity be identified as being related to a specific individual, but specific demographics and information as to how the products interact within an online social environment can be analyzed, thus leading to discovery of optimization techniques.

By being able to trace each succession of sales/experience to an identity of previous users, such influential users may be incentivized or rewarded, with money, discounts, prizes, special access, and the like. This can also serve to bring users and brands closer together, as the brands will be able to identify its most prolific “sales force” in a direct and reliable manner. Thus, sellers may be able to avoid intermediary fees typically paid to market their products by engaging directly with key influencers instead.

Currently, sellers measure effects among a user community in terms of “engagement,” However, “engagement” is more loosely defined in a digital media context, since measurements can only be made of interactions that do not relate to a relationship and commitment between sellers/brands and customers, as the term has historically been defined in the advertising/marketing industry. What digital content providers typically refer to as “engagement” now is related to action to click on certain links or “like” something. Neither of these actions truly says anything concrete to seller.

The measurement of direct cause and effect between a user recommendation and a purchase is concrete information that cannot be easily manipulated by those in a position to gain monetarily by manipulating the information. Media agency intermediaries can currently use the indefinite data regarding influencers to manipulate statistics to garner more income from sellers and advertisement media. Digital platforms can manipulate data through preferred placement of ads, search results, etc. Such manipulation can be drastically reduced or eliminated with use of the presently described techniques because sellers can receive accurate information directly from the market.

Another characteristic evident in the thanks process is that a user's privacy can be respected if the user does not want evidence of a purchase or another action that would indicate the user's motivation to do so. Sometimes, a user just wants to purchase or access an item and be sure that the user is out of the loop in future analytics relating to that product. In a system as described herein, such information may not be utilized by a third party or the content referral service provider unless the user has initiated the thanks process. In such a case, a user makes an explicit decision whether to participate in analysis of the dynamics of how ideas are spread and whether or not to credit a specific individual or entity as being the source of the user's motivation to take a certain action. That being the case, even if a buyer does not use the thanks process, if a buyer buys a product directly from a content referral by using an “action” feature included on the content referral, a determination can be made as to what motivated the buyer to purchase the product. The “action” feature allows the creator of a content referral to define certain actions that can be taken directly from the content referral, including an action to go directly to a provider and order the product. This feature allows more direct attribution of motivation than is currently found in other systems.

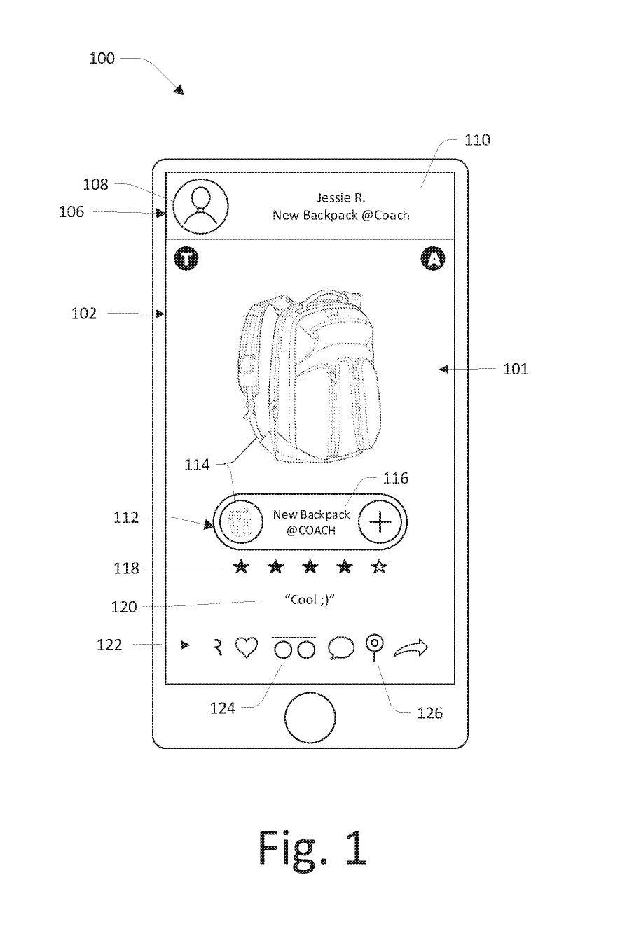

Other features and technological advancements of the systems and methods disclosed herein will be apparent from the present description and corresponding FIGS. 1-8.

### Content Referral: User Interface

FIG. 1 is a representation of a smart phone 100 depicting an example user interface 101 that displays a content referral 102 on a display 104 of the smart phone 100. The example user interface 101 also includes a title bar 106 that displays certain information related to the content referral 102, such as a personal icon 108 and a user name 110. The personal icon 108 may consist of a photograph of a user associated with the content referral 102, an avatar, a logo, or the like. The user name 110 may consist of a user's real name or alias, or an entity identifier, such as a company name, team name, etc. In the present example, the user name 110 is “Jessie R.” Other information may also be included as, in the present example, a subject and category associated with the content referral 102.

Another component of the example user interface 101 is a descriptor bar 112, which can contain various elements related to a subject of the content referral 102 shown in the example user interface 101. In the present example, the descriptor bar 112 includes a subject image 114 and a description field 116. Although the descriptor bar 116 is shown in the present example as having a limited number of components, one or more alternative implementations may utilize more or fewer components than those shown and described herein. The subject image 114 is a visual representation that may be related to a subject matter the content referral 102, such as a smaller version of a photo shown on the display, text related to content shown in the example user interface 101, or the like. The subject image 114 may also be unrelated to the subject matter of the content referral, such as in a case where the subject matter is an audio recording and the subject image 114 may simply an image that indicates the presence of an audio recording. The description field 116 is configured to display a description of content shown in the content referral 102 Such a description may vary by implementation, and at least one variation implements a description in the format of “subject@category,” wherein “subject” describes a subject of a content referral (such as a product, place, person, etc.) and “category” is a user-selected category of subjects (such as jeans, restaurants, Lady Gaga, etc.). A character may be used to separate the subject and category denotations, such as the “A” character used in this particular example. In the present example, the subject of the content referral 102 is a backpack, an image of which is shown on the display, and the category of the content referral 102 is “COACH”® because the backpack shown is purportedly made by COACH®. The subject image 114 is a smaller image of the backpack that is the subject of the content referral 102.

The content referral 102 in the example user interface 100 also includes a rating mechanism 118, a review dialog box 120, and multiple widget icons 122. The rating mechanism 118 can be any function that is capable of allowing a viewer of the content referral 102 to input a score from a range of scores, said score indicating the viewer's favorability rating, or sentiment, toward the subject matter of the content referral 102 shown in the example user interface 101. In the present example, a viewer may assign a rating of from one star to five stars. Alternative implementations may include a different variation of a rating input function, such as an assigning of a numerical value within a range such as one to ten, thumbs up and down, emoticons, etc. The review dialog box 120 is configured to accept input from a viewer that is not limited to any particular range of acceptable inputs, such as a text entry containing ASCII characters. In the present example, the example content referral user interface 101 indicates a rating of four stars out of five, and a review of “Cool;).” For clarity, it is understood that the content referral 102 was created by a first user, viewed by a second user, and the rating and review were entered into the content referral user interface 101 by the second user.

The widget icons 122 can be any number of icons configured to perform virtually any electronically-based task. In the present example, the widget icons 122 include several icons, including a “recycle” icon 124 and a “thanks” icon 126.”

The recycle icon 124 may be actuated by a viewer (i.e. “second user”) when the viewer wants to create a new content referral based on the existing content referral 102, i.e., the user “recycles” one or more components of the content referral 102. The recycle icon 124 may be implemented to work in conjunction with the thanks process, and such an implementation is described in greater detail below. The thanks icon 126 may be actuated by a viewer when the viewer wants to initiate the thanks process described herein to identify a source of a referral that will lead to or has led to an action taken by the viewer.

### Example System—Electronic Device

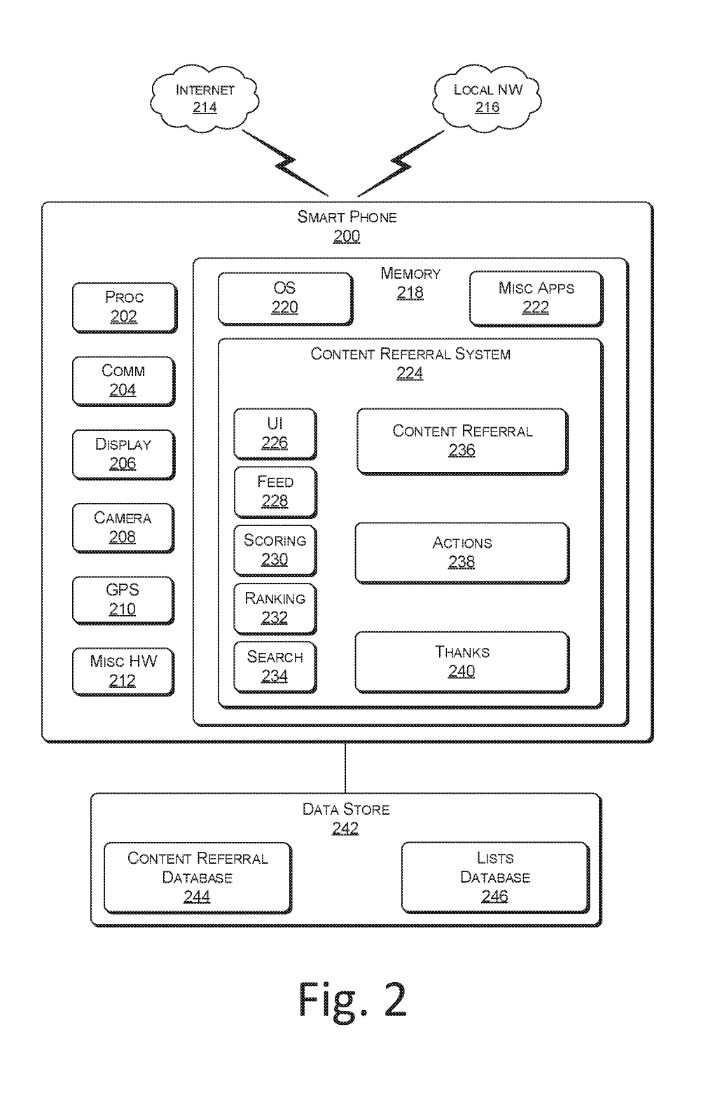

FIG. 2 is a block diagram representing an example electronic device on which one or more portions of the present inventions may be implemented. In this particular example, the example electronic device is a smart phone 200, but similar techniques would be employed on any other suitable type of electronic device, such as a tablet or a computer. In the following discussion, particular names have been assigned to individual components of the example smart phone 200. It is noted that a name of an element is exemplary only, and that a name is not meant to limit a scope or function of an associated element. Furthermore, certain interactions may be attributed to particular components. It is noted that in at least one alternative implementation not particularly described herein, other component interactions and communications may be provided. The following discussion of FIG. 2 merely represents a subset of all possible implementations. Furthermore, although other implementations may differ, one or more elements of the example smart phone 200 are described as a software application that includes, and has components that include, code segments of processor-executable instructions. As such, certain properties attributed to a particular component in the present description, may be performed by one or more other components in an alternate implementation. An alternate attribution of properties, or functions, within the example smart phone 200 is not intended to limit the scope of the techniques described herein or the claims appended hereto.

The example smart phone 200 includes one or more processors 202, one or more communication interfaces 204, a display 206, a camera 208, a Global Positioning System 210, and miscellaneous hardware 212. Each of the one or more processors 202 may be a single-core processor or a multi-core processor. The communication interface(s) 204 facilitates communication with components located outside the example smart phone 200, and provides networking capabilities for the example smart phone 200. For example, the example smart phone 200, by way of the communications interface 204, may exchange data with other electronic devices (e.g., laptops, computers, other servers, etc.) via one or more networks, such as the Internet 214 or a local network 216. Communications between the example smart phone 200 and other electronic devices may utilize any sort of communication protocol known in the art for sending and receiving data and/or voice communications.

The display 206 is a typical smart phone display in the present example, but may be an external display used with a smart phone or other type of electronic device. The camera 208 is shown integrated into the example smart phone 200, but may be an external camera used with the example smart phone 200 or a different type of electronic device. The GPS 210 or some other type of location-determining component is included. The miscellaneous hardware 212 includes hardware components and associated software and/or or firmware used to carry out device operations. Included in the miscellaneous hardware 212 are one or more user interface hardware components not shown individually—such as a keyboard, a mouse, a display, a microphone, a camera, and/or the like—that support user interaction with the example smart phone 200 or other type of electronic device.

The example smart phone 200 also includes memory 218 that stores data, executable instructions, modules, components, data structures, etc. The memory 218 can be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 220 is stored in the memory 218 of the example smart phone 200. The operating system 220 controls functionality of the processor(s) 202, the communications interface(2) 204, the display 206, the camera 208, the GPS 210, and the miscellaneous hardware 212. Furthermore, the operating system 220 includes components that enable the example smart phone 200 to receive and transmit data via various inputs (e.g., user controls, network interfaces, and/or memory devices), as well as process data using the processor(s) 202 to generate output. The operating system 220 can include a presentation component that controls presentation of output (e.g., display the data on an electronic display, store the data in memory, transmit the data to another electronic device, etc.). Additionally, the operating system 220 can include other components that perform various additional functions generally associated with a typical operating system. The memory 218 also stores miscellaneous software applications 222, or programs, that provide or support functionality for the example smart phone 200, or provide a general or specialized device user function that may or may not be related to the example smart phone 200 per se. The software applications 222 include system software applications and executable applications that carry out non-system functions.

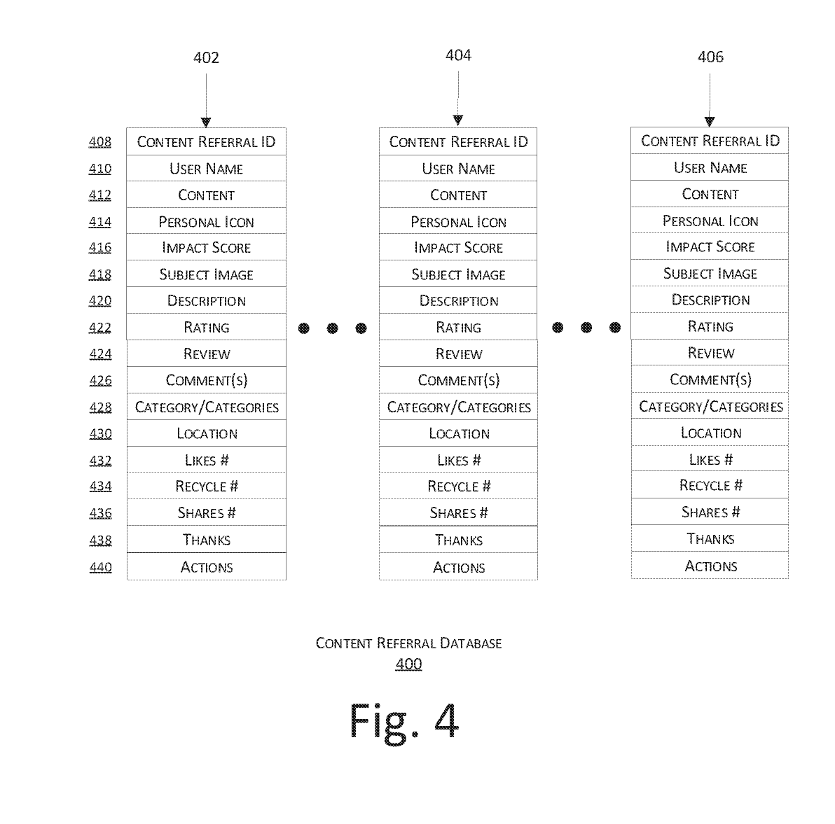

The memory 218 also stores a content referral system 224 that performs and/or controls operations to carry out the techniques presented herein and includes several components that work together to provide the improved systems, methods, etc., presently described. The content referral system 224 includes a user interface 226 and a content referral 236 created in the content referral system 224. The user interface 226 contains elements that support input and output communications between the example smart phone 200 and a user thereof. The user interface 226 also provides functionality for some user interface elements, such as functions represented by the widget icons 122 (FIG. 1) (i.e., functionality for attributes, like, recycle, comment, thanks, forward). The content referral 236, while not always present in the memory 218, is shown to represent a content referral such as the example content referral 102 (FIG. 1). Typically, the content referral 236 includes the data stored in a record of the example content referral database 400 (FIG. 4). The content referral system 224 also includes a feed 228 that generates and stores a user feed. One feature of a feed contemplated herein is that when a user's content referral receives thanks from another user, an indication of that will be included in the display of the content referral in the user's feed. Such an indication will be shown to the user's followers and/or other members of the public, which means the fact that the content referral received one or more thanks from other user will be publicized. The content referral system 224 further includes a scoring module 230, a ranking module 232, and a search module 234.

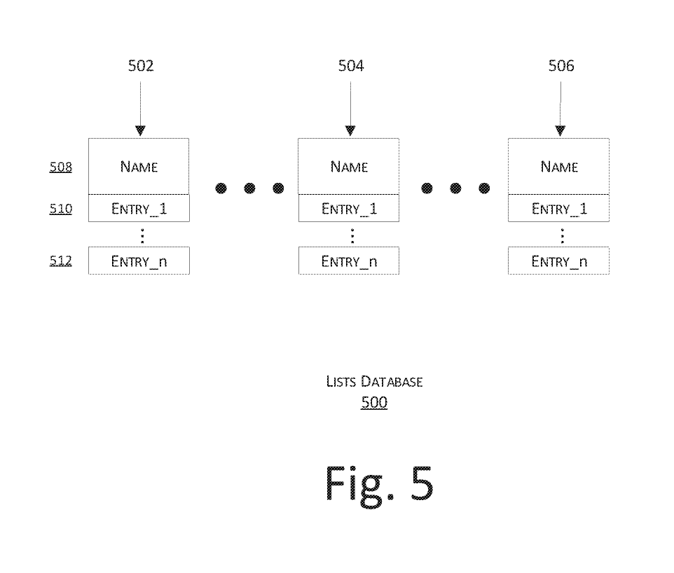

The example smart phone 200 communicates with a data store 242 that stores a content referral database 244 (similar to the example content referral database 400 shown in and described with respect to FIG. 4) and a lists database 246 (similar to the example lists database 500 shown in and described with respect to FIG. 5). Although shown located external to the example smart phone 200, at least some of the data stored in the data store 242 may be located in the memory 218 of the example smart phone 200. Typically, however, the content referral system 224 communicates with an external data store 242 to have access to the full features of content referrals and supporting applications associated with the content referral system.

Those skilled in the art will appreciate that variances on the described implementation(s) may be implemented to take advantage of system characteristics and provide an efficient operating environment.

### Example Server

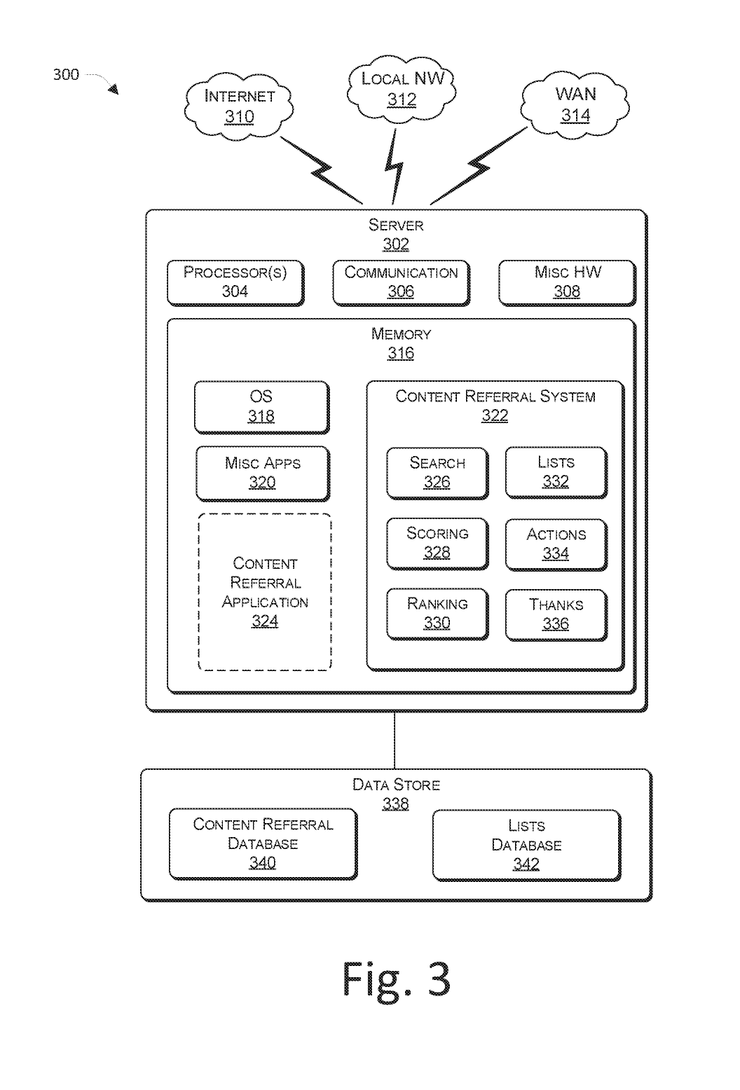

FIG. 3 is a block diagram depicting an example server operational environment 300 in accordance with the techniques described herein. In the following discussion, particular names have been assigned to individual components of the example server operational environment 300. It is noted that a name of an element is exemplary only, and that a name is not meant to limit a scope or function of an associated element. Furthermore, certain interactions may be attributed to particular components. It is noted that in at least one alternative implementation not particularly described herein, other component interactions and communications may be provided. The following discussion of FIG. 3 merely represents a subset of all possible implementations. Furthermore, although other implementations may differ, one or more elements of the example server operational environment 300 are described as a software application that includes, and has components that include, code segments of processor-executable instructions. As such, certain properties attributed to a particular component in the present description, may be performed by one or more other components in an alternate implementation. An alternate attribution of properties, or functions, within the example server operational environment 300 is not intended to limit the scope of the techniques described herein or the claims appended hereto.

The example server operational environment 300 contains a server 302 that includes one or more processors 304, one or more communication interfaces 306, and miscellaneous hardware 308. Each of the one or more processors 304 may be a single-core processor or a multi-core processor. The communication interface(s) 306 facilitates communication with components located outside the server 302, and provides networking capabilities for the server 302. For example, the server 302, by way of the communications interface(s) 306, may exchange data with client electronic devices (e.g., laptops, computers, other servers, etc.) via one or more networks, such as the Internet 310, a local network 312, or a wide area network 314. Communications between the example server 302 and other electronic devices may utilize any sort of communication protocol known in the art for sending and receiving data and/or voice communications.

The miscellaneous hardware 308 of the server 302 includes hardware components and associated software and/or or firmware used to carry out server operations. Included in the miscellaneous hardware 308 are one or more user interface hardware components not shown individually—such as a keyboard, a mouse, a display, a microphone, a camera, and/or the like—that support user interaction with the server 302 or other type of electronic device.

The server 302 also includes memory 316 that stores data, executable instructions, modules, components, data structures, etc. The memory 316 can be implemented using computer readable media as previously described, supra. An operating system 318 is stored in the memory 316 of the server 302. The operating system 318 controls functionality of the processor(s) 304, the communications interface(s) 306, miscellaneous hardware 308. Furthermore, the operating system 318 includes components that enable the server 302 to receive and transmit data via various inputs (e.g., user controls, network interfaces, and/or memory devices), as well as process data using the processor(s) 304 to generate output. The operating system 318 can include a presentation component that controls presentation of output (e.g., display the data on an electronic display, store the data in memory, transmit the data to another electronic device, etc.). Additionally, the operating system 318 can include other components that perform various additional functions generally associated with a typical operating system. The memory 316 also stores miscellaneous software applications 320, or programs, that provide or support functionality for the server 302, or provide a general or specialized device user function that may or may not be related to the server 302 per se. The software applications 320 include system software applications and executable applications that carry out non-system functions.

The memory 316 also stores a content referral system 322 that performs and/or controls operations to carry out the techniques presented herein and includes several components that work together to provide the improved systems, methods, etc., presently described. In addition to supporting services available through the content referral system 224 on the example smart phone 200 shown in FIG. 2, the content referral system 322 of the server 302 also performs global operations that function across multiple users, such as creating global lists, global scoring, global ranking, etc.

It is noted that although the presently described implementations contemplate individual users executing a content referral system on a personal device, the server 302 may include one or more instances of a client content referral system 324. In such a system, the core functionality of the content referral system is executed primarily on the server 302, and peripheral functionality, such as user input and output, content capture, etc., are performed on a user electronic device associated with an instance of a client content referral system.

The content referral system 322 includes a search component 326, a scoring component 328, a ranking component 330, and a lists component 332. The search component 326 is configured to receiving a search term from a client device and search an associated data store 338 for relevant information. The data store 338, can store many data items, such as user information, user feeds, user lists, global lists, product information, geographic information, business information, etc. The data stored is shown storing a content referral database 340 and a lists database 342 that are similar to those previously described. The data store 338 may be stored in the memory 316 of the server 302 or it may be stored in an external location that is accessible by the server 302. The scoring component 328 tracks activity associated with a subject of a content referral and adds or subtracts points based on various user input with respect to the content referral.

For example, the scoring component 328 may track any action of a user when the user is interacting with the content referral system 322 and assign a point value (negative, neutral, or positive) to that action. The assigned point value may then be added to an cumulative score. Virtually any indicator of a user's sentiment regarding a subject of a content referral may be assigned a point value to affect a cumulative score related to the user, the content referral, the content referral creator, etc. Furthermore, in addition to scoring actions taken within the content referral system 322, the scoring component 328 may also assign point values to external transactions in which the user participates.

The ranking component 330 is configured to rank different items within a category to order the items according to a score calculated by the scoring component 328. For example, if there is a category of restaurants, the ranking component will determine the ranked order of all content referrals related to an item associated with the restaurant category. Such ranking may be limited to a maximum number of items, such as ten (10), forty (40), or any other practicable number. The ranked order of items in a category are stored as lists in the lists component 332. The lists are global lists that take into account content referrals created by multiple users in the system, and/or they may be personal lists, which are rankings of one user's items in a category.

The content referral system 322 also includes an actions component 334 and a thanks component 336. The actions component 334 provides various actions that may be taken with respect to a content referral. Some examples of such actions include and action to go to a Wikipedia article on the subject of the content referral, an action to purchase an item that is the subject of the content referral, an action that provides a link to an article related to the subject of the content referral, and the like. As will be described in greater detail below, a user performing an action in the content referral system 322 can trigger a prompt to initiate a thanks process. The thanks component 336 includes code or other means to carry out the thanks process described herein.

As previously noted, the thanks process supported by the thanks component 336 provides a mechanism by which a second user can give credit to a first user who created or posted a content referral that included information that the second user found reliable for an action presently taken or to be subsequently taken by the second user. The second user can initiate the thanks process by actuating the thanks icon 126 included in a content referral user interface, such as the example content referral user interface 101 shown in and described with respect to FIG. 1. For example, if the second user is viewing the content referral 102 shown in FIG. 1 (showing the backpack as the subject image 114) and decides that she wants to purchase the backpack, the second user can actuate the thanks icon 126 if she wishes to give thanks to the user who created the content referral 102. It is noted that the first user 102 may not have been an original creator of the content referral 102, but may have recycled a previously-created content referral to make the content referral 102.

The thanks component 336 can be configured in one of several ways to effect different operations. One implementation can send a notification to the first user letting the first user know that the second user offered thanks for the content referral 102 posted by the first user. In some circumstances, it may be inordinately cumbersome for the first user to receive such notifications from every other user that is influenced by the content referral 102, such as if the first user is a celebrity and has thousands of followers. In such a case, the first user probably doesn't want to receive notification of every thanks from every user. To guard against such a case, the notification mechanism may be disabled by way of the thanks component 336. Another configuration may be implemented where the content referral 102 or the subject contained therein may be added to a personal list (e.g., a wish list) related to the second user when the second user initiates the thanks process.

When a first user receives thanks from a second user, a score associated with the first user may be incremented. For example, an influencer score may be implemented to indicate how many people rely on the recommendation of the first user. In such a case, the influencer score isn't calculated solely as a result of implied learnings, but reflects direct evidence of the first user's influence over other users. In an alternative implementation, a score associated with the second user may also be incremented to indicate a level of participation by the second user, or to encourage users to attribute credit to other users when it is deserved.

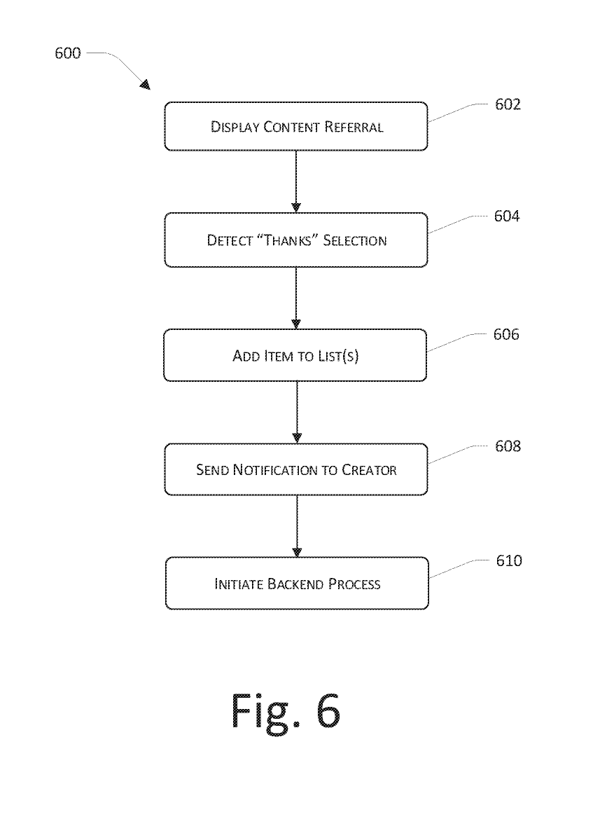

The thanks process is described in greater detail below, with respect to the flow diagrams of FIGS. 6-8.

### Content Referral Database

FIG. 4 depicts a representation of an example content referral database 400 that may be utilized with the techniques described herein. In the following discussion of the example content referral database 400, continuing reference is made to elements shown in and described with respect to previous figures. It is noted that the example content referral database 400 is only one particular implementation of a database that may be used to store information entered in content referrals. Those skilled in the art will recognize that similar databases or other storage, lookup, and recall techniques may be used with or in place of the example content referral database 400.

The example content referral database 400 includes multiple records, such as Record 402, Record 404, and Record 406. The records shown are for representative purposes only and the example content referral database 400, in practice, will contain a great number of records. Each record corresponds to a content referral created by a user, similar to the content referral 102 shown in FIG. 1. The example content referral database 400 stores some or all of the information entered by a user when the content referral is created. Each of the records 402-406 stores similar information.

As shown in FIG. 4, the records 402-406 include a content referral identifier 408, which is a unique identifier assigned to the content referral that corresponds to a record. The content referral identifier 408 is assigned by a system from information entered into the content referral, or created by the system in a content referral identification subsystem.

Each of the records 402-406 also includes a user name 410, content 412 captured by the corresponding content referral 102 (which may include any type of content), a personal icon 414, a score 416, and a subject image 418. Each record 402-406 is also shown storing a description 420, a rating 422, a review 424, and one or more comments 426 captured from other users' comments on the corresponding content referral 102. The records 402-406 in the example content referral database 400 also include one or more categories 428 that have been assigned to the corresponding content referral 102 by the user, a location 430 of the subject of the corresponding content referral 102 (if applicable), a number of likes 432 that the corresponding content referral 102 receives from users other than the user that created the content referral 102, a number of recycles 434 that have used one or more elements of the corresponding content referral 102, and a number of shares 436 of the corresponding content referral 102. Finally, each of the records 402-406 also includes entries for thanks 438 and actions 440. The thanks 438 entry is used to store the name of one or more persons that have credited a user for a referral to a place, product, or thing that is the subject matter of a content referral associated with the record 402-406. Actions 440 list one or more actions that a user who created the content referral has made available to a person who view the content referral (such as purchase a product, etc.).

Any information included in a content referral, whether it is entered by a user or captured from a source other than the user, may be stored in a record of the content referral database 400. To support a search function, the content referral database 400 is searchable on any element or combination of elements. It is noted that the example content referral database 400 may be implemented in many different ways, containing a greater or fewer number of records and/or entries than shown in the present example. Further characteristics of the example content referral database 400 are described in the context of certain functions, below.

### Lists Database

FIG. 5 depicts a representation of an example lists database 500 that may be utilized with the techniques described herein. In the following discussion of the example lists database 500, continuing reference is made to elements shown in and described with respect to previous figures. It is noted that the example lists database 500 is only one particular implementation of a database that may be used to store list information related to content referrals. Those skilled in the art will recognize that similar databases or other storage, lookup, and recall techniques may be used with or in place of the example lists database 500.

The example lists database 500 stores multiple records, as illustrated by Record 502, Record 504, and Record 506. Although only three records 502-506 are shown in the present example, many more records will be stored in the lists database 500 in operation. Each record 502-506 of the example lists database 500 includes a name 508 and one or more entries in a list associated with the name 508. The name 508 may be a category of a content referral. In such a case, the name 508 is taken from the description field 116 (FIG. 1) in a content referral. As previously notes, a description in the description field 116 can be in a format of subject@category. Thus, the category is a string of characters following the connecting symbol used in a particular implementation (in the present example, the connecting symbol is “@”). The name 508 may also be a person's name in the case of a personal list associated with a person. In addition, the name 508 may be other entities associated with a ranked list in at least one alternative implementation.

Each record 502-506 also includes a first entry, Entry_1 510, and other entries culminating with Entry n 512. A record 502-506 may only include a single entry (Entry_1 510), but will typically include multiple entries. A maximum number of entries for each category may vary between implementations. For example, one or more implementations may utilize “Top Ten” lists and, therefore, limit a number of entries associated with a category to ten (10). In one or more alternate implementations, a maximum of forth (40) entries per category may be allowed for example. In other implementations, a number of entries may not be limited at all.

### Example Methodological Implementation—Thanks (Unprompted)

FIG. 6 is a flow diagram 600 that depicts an example methodological implementation for a thanks process as described herein. In the following discussion of the flow diagram 600, continuing reference is made to the element names and/or reference numerals shown in previous figures. It is noted that although particular steps are described in the following discussion of the flow diagram 600, more or fewer steps may be included in an alternative methodological implementation. Furthermore, two or more discrete steps shown in and described with respect to the flow diagram 600 may be combined into a single step in a logical implementation of one or more of the techniques described herein. Also, although the following discussion refers to the content referral system 224 and components thereof shown in the example smart phone 200 of FIG. 2, it is noted that the same discussion may be applied with regard to the content referral system 336 of the example server 302 shown in FIG. 3. In some cases, operations may be performed on both the example smart phone 200 and the example server 302.

At step 602, the content referral system 224 causes the content referral 102 to be displayed on the display 206 of the example smart phone 200, including the thanks icon 126. At step 604, the content referral system 224 detects that a user has actuated the thanks icon 126 displayed in the content referral user interface 101. Subsequently, at step 606, the content referral system 224 adds the subject identified in the description field 116 to a list associated with the user, such as a personal top ten list, a wish list, etc. At step 608, a notification is sent to the creator of the content referral 102 informing the creator that the user has attributed thanks to the creator for a recommendation made in the content referral 102, i.e. for posting the content referral 102.

At step 610, a backend process is initiated. Many steps may be accomplished by the backend process, and they will vary depending on the particular implementation. For example, the backend process may include updating certain items, such as counts or scores associated with the content referral, elements contained in the content referral, a user who posted the content referral, a user who created the original content referral, the user initiating the thanks, and the like. Further actions that may be taken in the backend process include storing metadata associated with the thanks process, such as a date/time the thanks was sent, a location of the user sending the thanks, a location of an item displayed in the content referral, a name of the user sending the thanks, a brand or product name of an item displayed in the content referral, comments associated with the content referral, and the like. In sum, any action that an implementer wants the content referral system 224 to record about the context of a thanks initiation can be taken.

Furthermore, the fact that a thanks process is initiated may be used to provide information relative to a search by relating a subject of the content referral (i.e., a product, etc.) to the person being thanked for the content referral, so that a search performed with respect to the person being thanked for the content referral can also be directed to the subject of the content referral, and vice-versa. Or a relation can be made with the provider of the thanks attribution to form the basis for a more robust search.

Many implementation variations exist for the thanks process, and the limited examples provided herein are not meant to exemplify each such process. Those skilled in the art will recognize how attribution of motivation can be utilized to improve knowledge and operation of a content referral system and to provide a more accurate basis for determining who influencers are and how word of mouth spreads to reach many users.

### Example Methodological Implementation—Thanks (Prompted)

In addition to a user actuating a thanks icon to initiate a thanks process, a thanks process may be initiated by detecting when an attribution might be due and prompting a user to give an attribution (thanks), which the user may accept or decline. One context in which this might be done is when a second user creates a content referral by recycling a content referral created by a first user. Using examples previously provided herein, a user may actuate the recycle icon 124 when viewing the content referral 102. The recycle process takes a portion of the content referral 102 and creates a new content referral (not shown) that the second user can build on. When the content referral system 224 detects that a recycle event has occurred, it can prompt the user to give thanks to the creator of the content referral 102. This example is the basis for the methodological implementation outlined below.

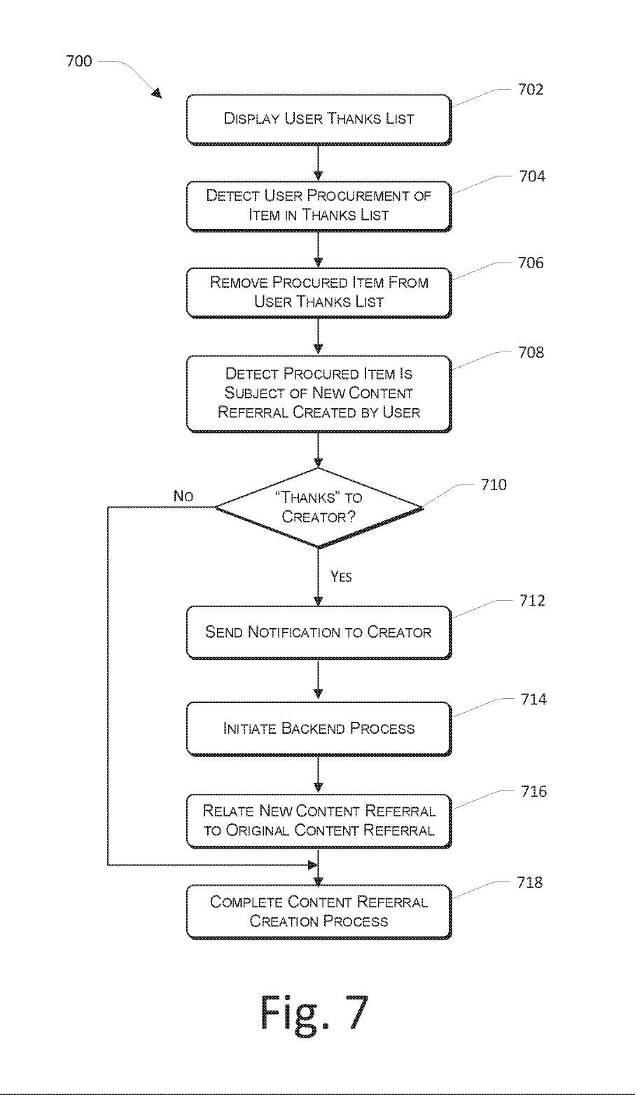

FIG. 7 is a flow diagram 700 that depicts an example methodological implementation for search for use in the techniques presented herein. In the following discussion of the flow diagram 700, continuing reference may be made to the element names and/or reference numerals shown in previous figures. It is noted that although particular steps are described in the following discussion of the flow diagram 700, more or fewer steps may be included in an alternative methodological implementation. Furthermore, two or more discrete steps shown in and described with respect to the flow diagram 800 may be combined into a single step in a logical implementation of one or more of the techniques described herein.

At step 702, a the content referral system 224 displays a thanks list associated with a user. The thanks list is a list of items that the user has, at some point, thanked a content referral creator for, as when a user gives thanks to a creator, the item (i.e. the content referral) is placed on a thanks list. The thanks list operates similar to a wish list used in some applications. At step 704, the content referral system 224 detects that the user has procured an item listed in the user's thanks list. At step 706, the content referral system 224 removes the procured item from the user's thanks list. If the user procures the item online by way of the thanks list, it is easy to determine that the procurement has been made. If, however, the user purchases the item offline, another method may be used to detect that the procurement has been made. That method is described in more detail below, with respect to step 708.

Subsequently—it may be immediately after the previous step or it may be a number of days later, the content referral system 224 detects that the user is creating a content referral that is based on the item previously procured (step 708). This is accomplished by matching a subject and category of a new content referral with a subject and category of an item on the user's thanks list. Even if the procurement was made in person and not by way of the content referral system, the same matching process can be accomplished if the user creates a new content referral using the same subject and category. In such a case, the prompting step below (step 710) may not be executed. However, other steps listed below may be performed so that the link between the user and a creator of the content referral that was placed on the user thanks list or wish list is still made for tracking and searching purposes.

At step 710, the content referral system 224 displays a prompt to the user asking if the user wishes to give attribution—or thanks—to a creator of the content referral that motivated the user to place the item shown in the content referral on the user's thanks list or a wish list. If the user does not wish to provide attribution (“No” branch, step 710), then the content referral creation process continues until completion at step 718. If the user wishes to provide attribution (“Yes” branch, step 710), then a notification is transmitted to the creator at step 712 to let the creator know that the user has procured the item and has sent thanks to the creator.

At step 714, a backend process is initiated, storing information and metadata and updating values related to the user, the creator, the newly-created content referral, the content referral that was on the user's thanks list, and/or elements contained in the content referral. At step 716, the newly-created content referral is associated with the original content referral so that a search that identifies the original content referral may also identify the newly-created content referral. Other associations may be made in this regard with respect to both users, both content referrals, and/or elements thereof. By making such an association that is reflected in the content referral database 400, the lists database 500, or another database (not shown), search results returned in response to a search query may be supplemented with additional information, thus providing better results and information to a user performing the search. After the thanks process has completed, the content referral creation process is continued and concluded at step 718.

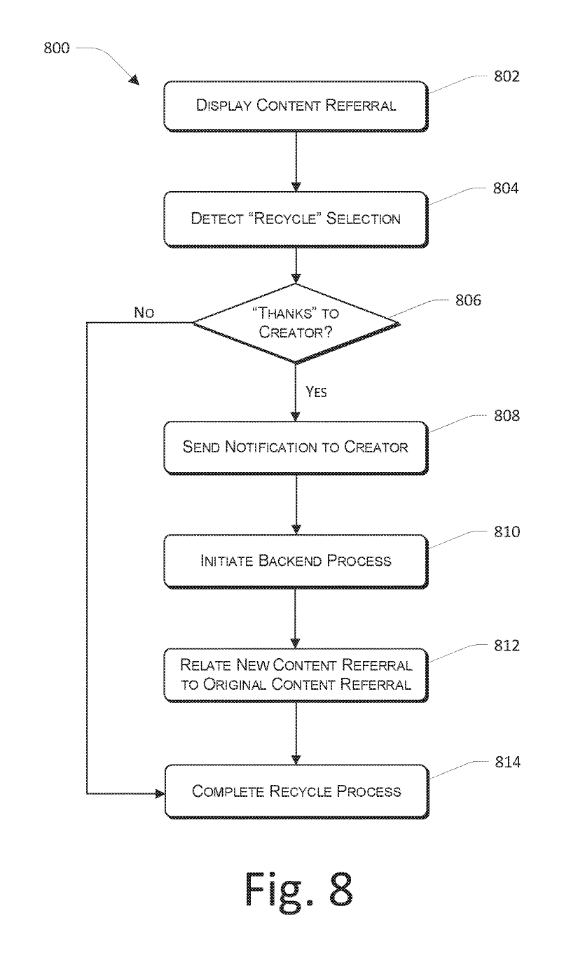

FIG. 8 is a flow diagram 800 that depicts an example methodological implementation for search for use in the techniques presented herein. In the following discussion of the flow diagram 800, continuing reference may be made to the element names and/or reference numerals shown in previous figures. It is noted that although particular steps are described in the following discussion of the flow diagram 800, more or fewer steps may be included in an alternative methodological implementation. Furthermore, two or more discrete steps shown in and described with respect to the flow diagram 800 may be combined into a single step in a logical implementation of one or more of the techniques described herein.

At step 802, a the content referral system 224 displays the content referral 102 on the display 206 of the example smart phone 200 to a second user (the content referral 102 having been created by a first user). At step 804, the content referral system 224 detects that the recycle icon 124 shown in the example content referral user interface 101 has been selected. At step 806, the content referral system 224 displays a prompt to the second user asking if the first user wishes to give attribution—or thanks—to the first user. If the second user does not wish to provide attribution (“No” branch, step 806), then the recycle process continues until completion at step 814. If the second user wishes to provide attribution (“Yes” branch, step 806), then a notification is transmitted to the first user at step 808 to let the first user know that the second user has sent thanks to the first user with respect to the content referral 102.

At step 810, a backend process is initiated, storing information and metadata and updating values related to the first user, the second user, the content referral, and/or elements contained in the content referral. At step 812, the newly-created content referral is associated with the original content referral so that a search that identifies the original content referral may also identify the newly-created content referral. Other associations may be made in this regard with respect to both users, both content referrals, and/or elements thereof. By making such an association that is reflected in the content referral database 400, the lists database 500, or another database (not shown), search results returned in response to a search query may be supplemented with additional information, thus providing better results and information to a user performing the search. After the thanks process has completed, the recycle process is continued and concluded at step 814.

It is noted that when the second user gives thanks to a first user in this manner, the thanks process may also be initiated with respect to an original user. For example, if the original user created an original content referral and the first user recycled the original content referral to create a recycled content referral, and the second user recycled the content referral created by the first user, when the second user provides attribution to the first user, the thanks process may also be initiated to provide attribution to the original user. Variations may be made to account for the different contexts of the original content referral and the recycled content referral.

Those skilled in the art will understand that various other contexts exist in which attribution of motivation may be desirable. Doing so helps to identify influencers as well as understand why people take certain actions and under what circumstances. Such an understanding will help create a better online environment for users by helping to provide them with information that is relevant to them when they need it.

### CONCLUSION

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method, comprising:
displaying a content referral created by an originator, said content referral including at least an element;
detecting a thanks activity that indicates a viewer of the content referral relied on the content referral to make a decision; and
storing information indicating that the originator influenced someone to make a decision.

2. The method as recited in claim 1, wherein the detecting a thanks activity further comprises detecting a thanks initiator that indicates a viewer of the content referral relied on the content referral to make a decision related to the element of the content referral.

3. The method as recited in claim 2, wherein the storing operation further comprises storing information indicating that the originator influenced someone to make a decision related to the element of the content referral.

4. The method as recited in claim 1, further comprising sending a notification to the originator that the viewer was influenced by the content referral to make a decision.

5. The method as recited in claim 1, wherein the thanks initiator further comprises a viewer selection of a thanks icon included in a content referral user interface.

6. The method as recited in claim 1, wherein the thanks initiator further comprises the viewer creating a new content referral from the content referral created by the originator.

7. The method as recited in claim 6, further comprising prompting the viewer to confirm that the viewer wants to perform all the operations of the method.

8. The method as recited in claim 1, further comprising adding the content referral to a list of content referrals associated with the viewer.

9. The method as recited in claim 1, further comprising adding the element to a list of items associated with the viewer.

10. The method as recited in claim 1, wherein the storing operation further comprises associating the originator with the element, and the method further comprises:
receiving a search query related to the originator; and
including the element in search results.

11. The method as recited in claim 10, wherein the storing operation further comprises associating the originator with the element such that a search query related to the element returns results related to the originator.

12. The method as recited in claim 1, wherein the element is a subject of the content referral.

13. The method as recited in claim 1, wherein the element is a category of the content referral.

14. The method as recited in claim 1, further comprising storing metadata related to the viewer and a context of the thanks initiator.

15. One or more computer-readable media containing processor-executable instructions that, when executed on a processor, perform the following operations:
displaying an element in a content referral created by an originator;
displaying a thanks icon with the content referral;
receiving an indication that the thanks icon has been selected by a viewer;
storing information associated with the thanks icon selection, said information indicating that a user thanked the originator for providing the content referral; and
associating the content referral, the element, the originator, and the viewer in a database such that search queries executed on the database can return results based on the association.

16. The one or more computer-readable media recited in claim 15, further comprising receiving a search query related to the originator and returning a result that identifies the content referral.

17. The one or more computer-readable media recited in claim 15, further comprising receiving a search query related to the originator and returning a result that identifies the element.

18. The one or more computer-readable media recited in claim 15, further comprising receiving a search query related to the element and returning a result that identifies the originator.

19. The one or more computer-readable media recited in claim 15, further comprising notifying the originator that someone has identified the originator as an influencer relative to the element.

20. A system, comprising:
a processor;
memory;
a display;
a content referral user interface displayed on the display, the content referral user interface including a thanks icon;
a content referral created by an originator and stored in the memory and displayed by way of the content referral user interface, the content referral including an element;
a searchable database;
a thanks component configured to receive an indication of selection of the thanks icon and to store data related to the element, and the originator in a searchable database such that the data identifies a relationship between the element and the originator; and
wherein a search query related to the element is executed against the originator, and a search query related to the originator is executed against the element.

21. The system as recited in claim 20, wherein a search result executed against the element and the originator returns a result identifying the relationship between the originator and the element.

22. The method as recited in claim 1, wherein the detecting a thanks activity further comprises determining that a second user created a content referral because of a content referral previously created by a first user.
